(19) United States
(12) Patent Application Publication
(10) Pub. No.: US 2020/0192825 A1
(43) Pub. Date: Jun. 18, 2020

(54) SECURITY FOR VIRTUALIZED DEVICE

(71) Applicant: ATI TECHNOLOGIES ULC, Markham (CA)

(72) Inventors: Philip NG, Markham (CA); Nippon Harshadk RAVAL, Markham (CA); Anthony ASARO, Markham (CA); Jeffrey G. CHENG, Markham (CA)

(21) Appl. No.: 16/223,820

(22) Filed: Dec. 18, 2018

(51) Int. Cl. G06F 12/14; G06F 12/1009; G06F 21/62; G06F 21/60; G06F 21/78; G06F 9/455

(52) U.S. Cl. CPC G06F 12/1475; G06F 12/1408; G06F 12/1009; G06F 2009/45583; G06F 21/602; G06F 21/78; G06F 9/45558; G06F 21/62

(57) ABSTRACT

A system has a processor including a plurality of processor cores, a memory controller, and an input-output memory management unit. The plurality of processor cores implements a plurality of virtual machines. The system further has a device in communication with the input-output memory management unit, the device including a bus controller, a device memory controller, an encryption module, a device memory, and a computational resource. The device is to implement a plurality of virtual functions. The device provides a device memory access request from a virtual function to the device memory controller. The virtual function is associated with a virtual function identifier. The device is to determine an encryption key associated with the virtual function, decrypt information stored at the device memory using the encryption key, and provide the decrypted information in a processor memory access request to the processor.

### BACKGROUND

In an increasingly data-driven economy, data processing and server systems are in high demand. With this high demand, efficient processing of data received via network interfaces is of greater interest. To improve processing efficiency, manufacturers have developed increasing complex multi-core processors and multi-processor systems. To further improve efficiencies, such systems provide virtual environments in which virtual machines are instantiated to allow separate processing of tasks and isolation of processes requested by different entities.

Such systems further rely on off-processor devices to enhance performance of the system. For example, off-processor devices include hardware accelerators, graphics processors, and network interface devices. Increasingly, virtual environments are being implemented on such devices. In some embodiments, off-processor devices can include physically remote device in communication with a processor, off-silicon devices in a chiplet-type device, or even a system-on-chip (SoC) where “off processor” is merely a logical, rather than physical, distinction. As virtual machines interact with virtual functions of the virtualized environment of such devices, there is a growing risk of unauthorized access of the information associated with the virtual function and corruption of the virtualized environment.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a block diagram of a system including a device implementing a secure virtual environment in accordance with some embodiments.

FIG. 2 is a block diagram illustrating the use of a translation lookaside buffer and page tables to identify secure memory addresses at the system of FIG. 1 in accordance with some embodiments.

FIG. 3 is a flow diagram of a method of processing memory access requests at the system of FIG. 1 to cryptographically protect information in accordance with some embodiments.

FIG. 4 is a block diagram of a function map table in accordance with some embodiments.

FIG. 5 is a block diagram of a set of tables used to implement a function page table in accordance with some embodiments.

FIG. 6 is a flow diagram of a method of processing memory access requests at the system of FIG. 1 to limit access to information in accordance with some embodiments.

### DETAILED DESCRIPTION

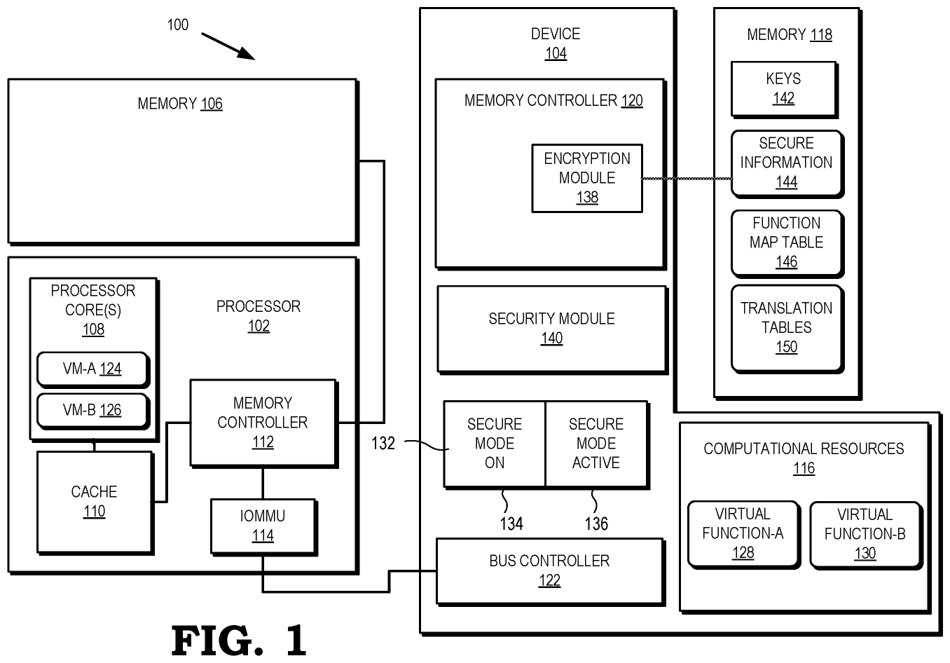

FIGS. 1-6 illustrate techniques for protecting information in a device in communication with a processor implementing a virtual environment. In some embodiments, the system includes a processor and a device in communication with the processor. The processor can include a plurality of processor cores, a cache memory, a memory controller, and an input-output memory management unit. The device is in communication with the input-output memory management unit and includes computational resources, device memory, a device memory controller, and a security module. The processor can implement a virtual environment in which a plurality of virtual machines is implemented on a plurality of processor cores. The device can further implement a virtual environment in which virtual functions implemented on the computational resources communicate with the virtual machines, exchanging information between the device and the input-output memory management unit of the processor. In particular, the virtual functions can provide information to memory locations accessible to the virtual machine or can retrieve information from memory locations accessible by the virtual machine. The virtual functions implemented on the computational resources of the device can access secured spaces within the device memory. In some embodiments, a memory controller of the device includes an encryption module that encrypts or decrypts information for storage in a secured information portion of the device memory based on a key associated with the virtual function accessing the information. The device can further include a security module that assigns keys to virtual functions.

In some embodiments, a virtual function provides a memory access request to the device memory controller. The device memory controller acquires an encryption key associated with the virtual function and, utilizing an encryption module, encrypts or decrypts information from the secured information portion of the device memory. In some embodiments, the virtual function directs the information to be sent in a memory access request to the virtual machine implemented on the processor via a bus connected to the input-output memory management unit of the processor. The memory controller of the processor can inject the information to the appropriate cache memory or off-processor memory. In some embodiments, the virtual function provides a processor memory access request to retrieve information from the processor or virtual machine implemented on the processor. When such information is provided from the input-output memory management unit to the device, the virtual function can direct the storage of the information on the device memory. The device memory controller can encrypt the information with an encryption key associated with the requesting virtual function, and the information can be stored in an encrypted format in the secure information portion of the device memory.

In some embodiments, the device implements methods to isolate information stored on the device memory so that virtual functions cannot access information stored by other virtual functions. For example, the device can include a function map table mapping physical addresses to the virtual functions to which they are assigned. When the virtual function requests access to device memory, the memory controller compares the virtual function identifier of the virtual function to an identifier associated with the physical address to determine whether that physical addresses is paired with the virtual function. If the virtual function is not paired with the physical address, the device memory access request can be denied. Accordingly, when the physical address has been assigned to the virtual function as indicated by the function map table, the memory access request can be fulfilled, and access to the information can be provided to the virtual function making the request.

FIG. 1 is a block diagram of a system 100 that includes a processor 102, a device 104, and a memory 106. The processor system can be incorporated in any of a variety of electronic devices, such as a server, personal computer, tablet, set-top box, gaming system, smart TVs, handsets, and the like. The processor 102 is generally configured to execute sets of instructions (e.g., computer programs) that manipulate the circuitry of the processor 102 to carry out defined tasks. The memory 106 facilitates the execution of these tasks by storing data and instructions used by the processor 102. The memory 106 can be random access memory (RAM), nonvolatile memory, such as flash memory or a hard disk drive (HDD), and the like, or a combination thereof. The processor system 100 also includes a device 104. The device 104 can be, for example, a network interface card (NIC), a host bust adapter (HBA), a hardware accelerator, a graphics accelerator including a graphics processing unit (GPU), or the like.

The processor 102 includes a plurality of processor cores 108, cache memory 110 accessible to the processor cores 108, a memory controller 112, and an input-output memory management unit 114. The processor cores 108 are processor units that individually and concurrently execute instructions. In some embodiments, each of the processor cores 108 includes an individual instruction pipeline that fetches instructions, decodes the fetched instructions into corresponding operations, and using the resources of the processor system 100 executes various operations. While FIG. 1 illustrates a single block of processor cores 108, the processor 102 can include two processor cores, three processor cores or more than three processor cores. Each of the processor cores 108 can have a low-level cache dedicated to the processor core. For example, a processor core of the processor cores 108 can have a Level 1 cache or a Level 2 cache. Each of the processor cores 108 can further include a translation lookaside buffer.

The processor 102 can further include a higher-level cache or shared cache, such as cache memory 110. The memory controller 112 controls access and manages information stored on the various levels of cache or the memory 106.

The processor 102 also includes an input-output memory management unit (IOMMU) 114 that is used connect to devices, such as the device 104, to the memory controller 112. In some embodiments, the IOMMU 114 communicates with the device 104 using a serial bus. The serial bus can comply with a bus standard, such as the Peripheral Component Interconnect Express (PCIe) serial bus standard. The memory controller 112 provides an interface for the device 104 to communicate with the memory 106 or with one or more levels of cache memory. The IOMMU 114 receives memory access requests (e.g., a direct memory access request) from the device 104 and controls provisions of those requests to the memory 106 or to cache memory via the memory controller 112.

In some embodiments, the processor 102, at the memory controller 112, includes a physical tag translation table to the translate physical steering tags received from the IOMMU 114 into a physical resource targeted by an associated processor memory access request received from a device. In addition, the memory controller 112 receives responses to memory access requests from the memory 106 or cache memory and controls provisions of the responses to the device 104.

The device 104 includes computational resources 116, device memory 118, and a memory controller 120. The device computational resources 116 are generally configured to execute sets of instructions (e.g., computer programs) that manipulate the circuitry of the device 104 to carry out defined tasks. In some embodiments, the computational resources 116 include specialty circuitry designed to execute specific instruction sets faster than a general-purpose central processing unit. For example, the device computational resources 116 can carry out graphics processing, logic processing, or processing of network traffic, using specialized configurations to carry out such processing separate from a general-purpose processor and often faster than a general-purpose processor.

The device memory 118 facilitates the execution of instructions to be processed on the device computational resources 116 by storing data and instructions used by the device 104. The device memory 118 can be a random-access memory, nonvolatile memory such as flash memory, and the like, or a combination thereof. In some embodiments, the device memory 118 can further include memory stored off the device, such as memory 106, which can, for example, be a shared memory resource accessible by both the device 104 and the processor 102.

The device 104 further includes a bus controller 122 in communication with the input-output memory management unit 114 of the processor 102. In some embodiments, the bus controller 122 of the device 104 communicates with the input-output memory management unit 114 of the processor 102 using a serial bus. The serial bus can comply with a bus standard, such as the Peripheral Component Interconnect Express (PCIe) serial bus standard.

The processor 102 implements a virtualized environment in which virtual machines are implemented on processor cores 108. For example, the processor 102 implements a Virtual Machine-A 124 or a Virtual Machine-B 126 on one or more of the processor cores 108. While not illustrated, the processor cores 108 further implement a hypervisor to manage the virtual machines and to assign the virtual machine to a processor core. To support the virtual machines, the device 104 implements virtual functions, such as Virtual Function-A 128 or Virtual Function-B 130 using the computational resources 116. A virtual machine is assigned to interact with the virtual function implemented on the device 104. For example, the VM-A 124 implemented on a processor core 108 of the processor 102 can interact with a VF-A 128 implemented on the device 104. In another example, the VM-B 126 implemented on a processor core 108 of the processor 102 can interact with the VF-B 130 of the device 104.

Depending on its functionality, a virtual function can be requested to perform a task and provide information resulting from the task into the memory hierarchy accessible by the processor core implementing the virtual machine or to retrieve information stored in the memory hierarchy of the processor 102 to perform the function directed by the virtual machine. As such, more than one virtual function (e.g., VF-A 128 or VF-B 130) can access computational resources 116 and the device memory 118 at the direction of a virtual machine implemented on the processor 102.

In some embodiments, the device 104 implements security modes to isolate and secure information associated with each virtual function. In some embodiments, a switch 132 initiates a secure mode 134 and activate the secure mode 136. In the secure mode, a virtual function requesting device memory access from the memory controller 120 to access information stored in the device memory 118 can be assigned an encryption key 142. Information stored in the device memory 118 and associated with the virtual function can be encrypted based on the encryption key assigned to the virtual function. In some embodiments, the device 104 includes a security module 140 that assigns keys 142 to the virtual function 128 or 130. To access the secure information 144, encryption module 138 uses the encryption key 142 associated with the virtual function (e.g., VF-A 128 or VF-B 130). When writing information to device memory 118, the memory controller 120 can direct the encryption module 138 to encrypt the information using the key 142 associated with the virtual function and store the information as secure information 144. When reading information from the device memory 118, the memory controller 120 can direct the encryption module 138 to decrypt information from the secure information 144 using the key 142 associated with the virtual function requesting the information.

For example, when the secure mode is on and active and VF-A 128 is initiated on the device computational resources 116, a security module 140 can assign a key 142 to the VF-A 128. When the virtual function VF-A 128 makes a memory access request of the memory controller 120, the memory controller 120 using the encryption module 138 and the key 142 associated with VF-A 128 can write or read the secure information 144 and encrypt/decrypt the information. For example, a VF-A 128 requests information be stored in the device memory 118. The memory controller 120 identifies an encryption key 142 associated with VF-A 128 and utilizes an encryption module 138 to encrypt the information and store the secure information 144 on the device memory 118. When VF-A 128 provides a device memory access requests to the memory controller 120 to retrieve information from the device memory 118, the memory controller 120 can access the encryption key 142 associated with the VF-A 128 and use the encryption key 142 to decrypt the secure information 144 using the encryption module 138. In such an example, a virtual function, such as VF-B 130, attempting to access the secure information 144 stored on the device memory 118 encrypted using the encryption key 142 associated with VF-A 128 would be unable to decrypt the information stored using an encryption key assigned to a different virtual function. As such, the encryption prevents unauthorized reading of information stored by a different virtual function.

In some embodiments, the device 104 further implements methods for limiting access to addresses within the device memory 118 by virtual functions not assigned to access those addresses. For example, physical addresses of the device memory 118 are assigned to a virtual function implemented on the computational resources 116 of the device 104. When a physical address of the device memory 118 is assigned for use by a virtual function, an identifier associated with the virtual function can be paired with the physical address and stored in a function map table 146. When a virtual function requests memory access, the memory controller 120 can compare an identifier of the virtual function with an identifier associated with the physical address being accessed to determine whether the virtual function has been assigned access to that physical address. In a virtual environment, a virtual function, such as VF-A 128 can provide a memory access request to the memory controller 120. The memory access request can include a virtual address. The memory controller 120 can access translation tables 150 to translate the virtual address to a physical address. For example, the translation tables can include translation lookaside buffers or page tables depending on the configuration of the device memory 118. Using the physical address, the memory controller can compare an identifier associated with the physical address in the function map table 146 with the identifier of the virtual function, such as VF-A 128, to determine whether VF-A 128 can access the information stored at the physical address. When the identifiers match, the memory controller 120 can proceed with processing the memory access request. If VF-B 130 attempts to access the same physical address in the device memory 118, the identifier associated with the physical address in the function map table 146 is different than the identifier of VF-B 130. As such, the memory controller 120 prevents access to the information at the physical address.

In a virtualized environment implemented on the device, the use of the function map table 146 in conjunction with the translation of virtual addresses to physical addresses of the device memory 118 can prevent virtual functions attempting to access physical addresses or pages to which they are not assigned.

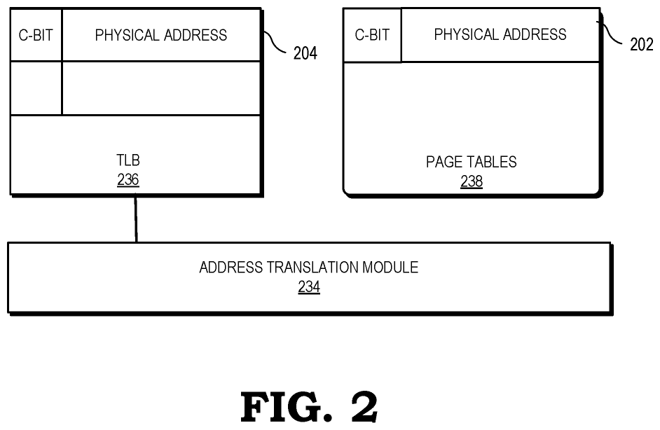

FIG. 2 illustrates a portion of the device memory controller 120 to enable identification of a security type (e.g., secured or non-secured) for memory access requests in accordance with some embodiments. In particular, FIG. 2 depicts an address translation module 234 and a translation lookaside buffer (TLB) 236. The address translation module 234 is generally configured to receive from VFs (e.g., VF-A 128 and VF-B 130 of FIG. 1) virtual addresses for corresponding memory access requests. The address translation module 234 translates each received virtual address to a corresponding physical address that identifies the location of the device memory 118 targeted by the memory access request.

The address translation module 234 employs translation resources. The type of translation resource and method for translation of addresses can vary depending on the type and configuration of the memory resource. In some embodiments, one or both of a translation lookaside buffer (TLB) 236 and the page tables 238 (e.g., in memory 118 of FIG. 1) are used to translate a virtual address to a corresponding physical address. The page tables 238 include a plurality of entries (e.g., entry 202) indexed by virtual address. In some embodiments, the page tables 238 are multi-level page tables, whereby higher-level pages include entries that identify other pages associated with the virtual address, with the lower level pages identifying the physical address assigned to the virtual address. The physical address can be identified by traversing the page tables in a page walk, wherein the highest level page is accessed first to identify the page at the next level that is to be accessed, and so on until the lowest level page table that includes the physical address is identified and the physical address retrieved from that highest level page table. The lowest level page tables also store an indicator, such as a bit (designated the “C-bit”), that indicates whether the data corresponding to the physical address is to be cryptographically protected. The TLB 236 includes a plurality of entries (e.g., entry 204) that together store a subset of the entries of the page tables 238 that reflect the virtual addresses recently received by the address translation module 234.

In response to receiving a virtual address, the address translation module 234 accesses the TLB 236 to determine whether it includes an entry corresponding to the virtual address. The indicator or C-bit portion of the address is used by the device memory controller 120 to identify whether the memory access request is a secured memory access request. Thus, for example, if the C-bit in the physical address value is in an asserted state, the memory controller 120 identifies the corresponding memory access request as a secured memory access request, and the memory controller 120 looks up the virtual function (VF) TAG corresponding to the requestor. The address translation module 234 appends the VF TAG value to the physical address and provides the resulting physical address value to be used by the encryption module to look up security keys. If the C-bit in the page table entry is deasserted, the memory controller 120 does not append the VF TAG to the physical address, and memory access proceeds without encryption or decryption.

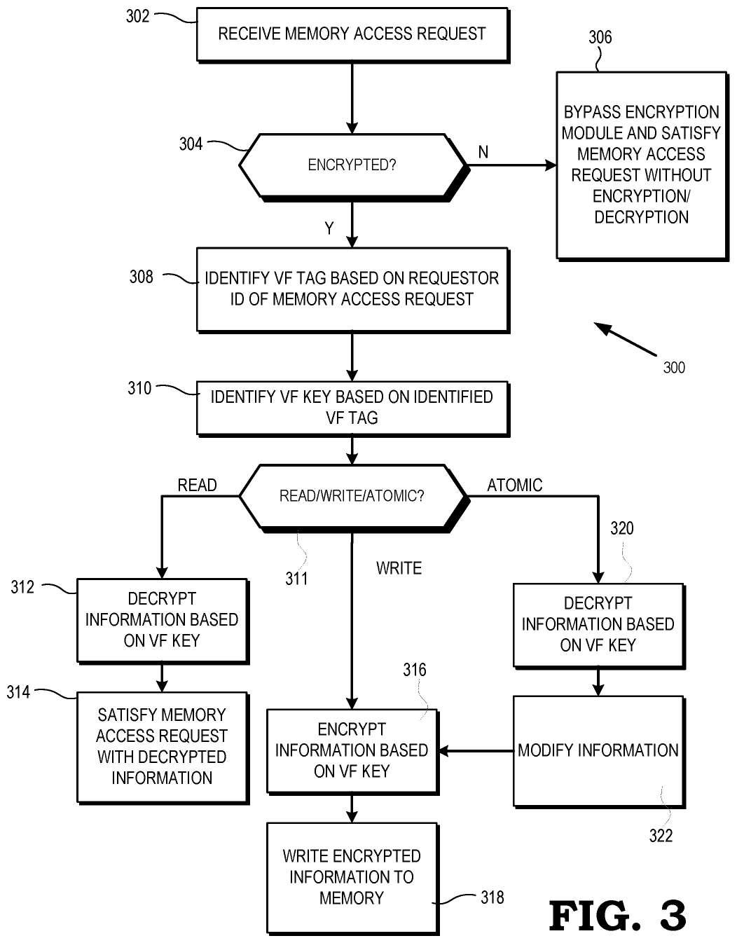

FIG. 3 illustrates a flow diagram of a method 300 of processing direct memory access requests at a device memory controller to protect information designated for cryptographic protection in accordance with some embodiments. For purposes of description, the method 300 is described with respect to an example implementation at the device memory controller 120 of FIG. 1. At block 302, the device memory controller 120 receives a memory access request from a requestor VF. The memory access request may be a request generated by one of the VFs 128 or 130. As described above with respect to FIGS. 1-2, the address value for the memory access request may include a C-bit value indicating whether the memory access request is a secure memory access request, and a requestor ID value identifying the requestor VF.

At block 304, the memory controller 120 determines whether the C-bit for the memory access request is asserted. If not, the memory access request is a non-secure memory access request, and the method flow moves to block 306 and the device memory controller 120 bypasses the encryption module 138 and satisfies the memory access request. In the case of a write request, the device memory controller 120 does not encrypt the write information, so that the device memory 118 stores the write information in unencrypted form. In the case of a read request, the device memory controller 120 retrieves the information from the device memory 118 and provides it to the requestor VF without decrypting the information.

Returning to block 304, if the device memory controller 120 identifies that the C-bit for the memory access request is asserted, then the memory access request is a secure memory access request. Accordingly, the method flow moves to block 308 and device memory controller looks up a VF TAG based on the requestor VF's requestor ID. The VF TAG is provided to the device memory controller 120 and the method flow proceeds to block 310.

At block 310, the device memory controller 120 identifies one of the security keys 142 corresponding to the provided VF TAG. The encryption key can be used with read requests to decrypt information, write requests to encrypt information, or other partial read/write request to both decrypt and encrypt information. At block 311, the memory controller identifies the nature of the memory access request as read, write, or a partial read/write, such as an atomic request.

At block 312, in a read request, the encryption module 138 decrypts the information retrieved from memory to be used to satisfy the memory access request. If the memory access request is a read request, the device memory controller 120 retrieves the information to be read from the device memory 118 and the encryption module 138 decrypts the retrieved information using the identified security key.

At block 314, the device memory controller 120 satisfies the memory access request using the decrypted information. In some embodiments, the memory access request can be an information request from a virtual machine implemented on a processor in communication with the device. The decrypted information can be returned to the processor for access by the virtual machine. In some embodiments, the memory access request can include instructions for the virtual function to access and process the information. For example, a virtual function implemented on a graphics processing unit can access encrypted information and use the information to generate an image.

Returning to block 311, when the request is a write request, the encryption module 138 can encrypt the information, and the information can be written to memory, as illustrated at block 318.

In a request that involves a partial read, modify and write, the information can be decrypted by the encryption module 138. The information can be modified, as illustrated at 322. The modified information can be encrypted using the encryption key, as illustrated at 316, and the encrypted modified information can be stored in memory, as illustrated at 318.

To further secure information stored in the device memory 118, memory access can be limited by associating physical addresses with virtual functions (e.g., VF-A 128 or VF-B 130) implemented on the device 104. Memory access can be terminated when a virtual function request access of an address not associated with the virtual function.

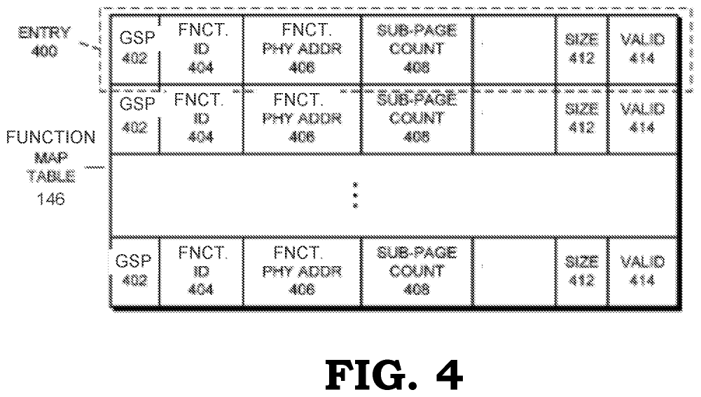

FIG. 4 presents a block diagram illustrating a function map table 146 in accordance with some embodiments. The function map table 146 includes information that is used, among other things, to determine whether a translation of a virtual address returns a device physical address.

In some embodiments, the function map table 146 includes a number of entries 400 (an entry 400 is highlighted using a dashed line in FIG. 4). Each entry in function map table 146 includes information about a corresponding page in device memory (e.g., each 4 kB page in memory that may be allocated for use by one or more virtual functions). The entries in function map table 146 are indexed using device physical addresses associated with each page, so that each entry is associated with a particular device physical address. For example, for 4 kB pages, a first entry in function map table 146 may be associated with a first or lowest allocatable device physical address (address A), a second entry may be associated with a second allocatable device physical address (address A+4 kB), and so forth. In this way, when a particular device physical address is to be looked up in function map table 146, an entry at a corresponding offset in function map table 146 may be looked up. In some embodiments, a base address of the function map table 146 is recorded in a specified, and possibly secure, location in system 100 to enable the offset-based lookups.

In the function map table 146, each entry 400 is configured to store global shared pages (“GSP”) 402, function identifier (“FNCT. ID”) 404, function physical address (“FNCT. PHY ADDR”) 406, sub-page count 408, access indicator 410, size indicator 412, and valid indicator 414. Global shared pages 402 is an indicator of whether the corresponding page is shared by two or more virtual functions.

The function identifier 404 is an identifier associated with a virtual function to which the corresponding page is allocated. For example, when the corresponding page is allocated for the use of a particular virtual function, an identifier for the particular virtual function is recorded in function identifier 404. The function identifier 404 can hold an address space identifier (“ASID”), an ID string, a name, and/or another value that specifically identifies a virtual function.

The function physical address 406 is a value that represents a function physical address that is associated with the device physical address for the entry. For example, when a page at a given device physical address is allocated for the use of a virtual function, the function physical address to be used by the virtual function for addressing the page is recorded in the corresponding entry 400 in function map table 146. In this way, a record is made of the particular function physical address to be used by the virtual function for which each page is allocated. As described below, recording this information enables the table walker to determine, when checking a device physical address acquired during a walk of a nested page table, whether the device physical address maps to the expected function physical address, i.e., whether the device physical address has been mapped to two different function physical addresses at the same time. This can enable detecting whether the mapping has been changed maliciously or erroneously.

The sub-page count 408 is a count of smaller-sized pages allocated for virtual function(s) within a larger-sized page. For example, in a system that supports 2 MB pages and 4 kB pages, a page on a 2 MB boundary (e.g., pages at addresses A, A+2 MB, A+4 MB, etc.) can have a count of 4 kB pages within the 2 MB page that have been allocated for use by a virtual function. The sub-page count value can be used to determine whether an access to a larger-sized page is impermissible, given that smaller pages have been allocated within the larger-sized page, i.e., to avoid an impermissible access made using an improper page size.

The size indicator 412 is a page size expected from the page table. For example, assuming 4 kB pages and 2 MB pages are used in device memory 118, the size indicator 412 can indicate whether the page corresponding to the associated function physical address should be 4 kB or 2 MB. The size indicator 412 enables detection of mismatched expectations, such as a page table translation using a 2 MB page where the RMT indicates an expected 4 KB page.

The valid indicator 414 is an indicator of whether the entry 400 currently holds valid information, i.e., whether the information that is currently in the entry 400 is stale, outdated, etc., or is useable. The valid indicator 414 is used to prevent the use of information from entries 400 in the function map table 146 that are stale, but may still contain old information (undeleted information, random bit patterns, etc.), that are initialized, but do not contain actual information, etc.

Although the function map table 146 is described with various information in each entry, in some embodiments, a different arrangement or type of information may be present in each entry. Generally, the entries 400 in function map table 146 includes sufficient information to perform the operations herein described.

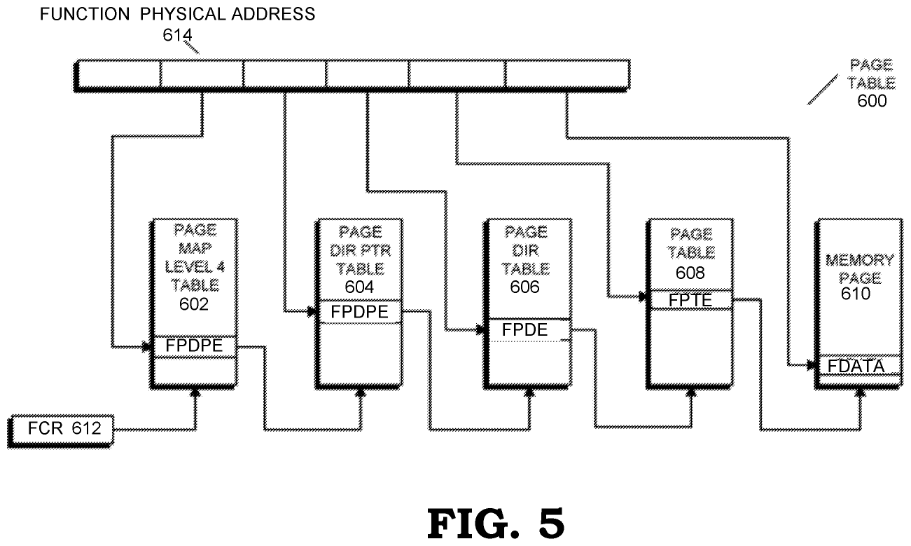

The device uses a hierarchy of page tables for performing address translations. FIG. 5 presents a block diagram illustrating a set of tables used to implement a nested page table in accordance with some embodiments. The function page table 600 includes page map level 4 table 602, page directory pointer table (“PAGE DIR PTR TABLE”) 604, page directory table (“PAGE DIR TABLE”) 606, page table 608, and function memory page 610. Page map level 4 table 602, page directory pointer table 604, page directory table 606, and page table 608 are data structures (e.g., tables, linked lists, etc.) that are stored in device memory 118. The page map level 4 table 602, page directory pointer table 604, and page directory table 606 each include information about a subsequent table to be searched (or “walked”) during a next step of a table walk to find a device physical address. Page map level 4 table 602 includes a number of entries, each of which includes information mapping corresponding sub-sets of address bits from function physical addresses to page directory pointer tables (such as page directory pointer table 604).

The page table 608 includes device physical addresses indicating particular device memory pages associated with corresponding portions of function physical addresses. The function memory page 610 is a specific page (or a virtual page) in memory where data indicated by a function physical address 614 is located (recalling that function physical addresses may need to be translated to device physical addresses to enable accessing data in memory).

In some embodiments, when performing a table walk in function page table 600 to acquire a device physical address that is associated with a function physical address, a table walker reads function control register (“FCR”) 612 to determine a location, in memory, of a page map level table associated with the corresponding virtual function (e.g., page map level 4 table 602). The table walker then searches (or “walks”) the page map level 4 table 602 using a sub-set of the bits from the function physical address (e.g., bits 39-47 of a 64-bit virtual address) for an entry (shown as “FPML4E”) indicating a location of a page directory pointer table to be walked next (e.g., page directory pointer table 604). The table walker next proceeds through the remaining tables, i.e., the page directory pointer table 604, a page directory table (e.g., page directory table 606), and a page table (e.g., page table 608), using corresponding sub-sets of bits from the function physical address to walk each table and locate an entry in the table (shown as “FPDPE” and “FPDE”) that indicates a next table to be walked. Eventually, using a device physical address acquired from the page table 608 (shown as “FPTE”), the table walker arrives at a particular function memory page (e.g., function memory page 610). Using a corresponding portion of bits of the function physical address 614 (e.g., bits 0-11 of the 64-bit virtual address), the table walker determines an entry (FDATA) in the function memory page 610 that includes data indicated by the function physical address. If the table walker is unable to find an address translation for the function physical address, an error-handling operation is performed (e.g., a page fault is emitted and subsequently processed, etc.).

As described herein, address translation information may be modified/changed, updated, etc. after being added to a function page table 600. For example, when a page is moved from a first location to a second location in memory, re-assigned from a first virtual function to a second virtual function, etc., one or more tables in the set of tables can be updated accordingly. As another example, the device may improperly (maliciously, erroneously, etc.) update an address mapping in function page table 600, such as by writing incorrect information in one or more tables in the set of tables. The described embodiments use the function map table 146 to avoid using improperly updated information from function page table 600. In other words, the described embodiments enforce rules such as each page in memory is only permitted to be associated with a single/unique function physical address (no function physical address aliasing is allowed), and in-use private function pages cannot be remapped without involving the corresponding virtual function as described herein.

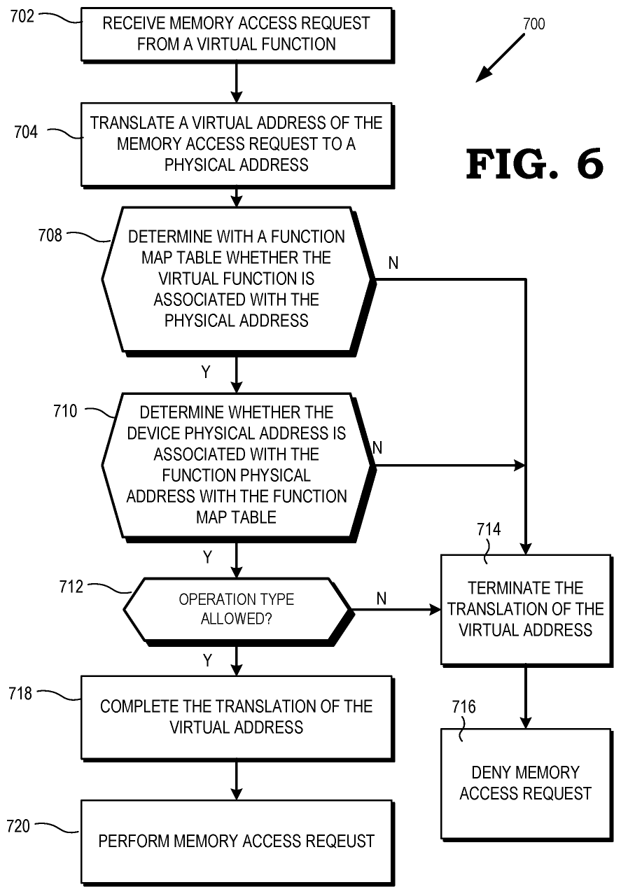

Although a particular arrangement of tables is shown in FIG. 6, in some embodiments, a different number and/or arrangement of tables is used. For example, in some embodiments, only a single table is used, the single table mapping function physical addresses to device physical addresses.

FIG. 7 is a block flow diagram 700 of a method for limiting access to physical addresses within a device memory. At block 702, a memory controller receives memory access requests from a virtual function. The memory access request can be a read request. The memory access request can be a write request. In a virtual environment, the memory access request includes the virtual address.

At block 704, the memory controller translates a virtual address of the memory access request to a physical address. Depending on the nature of the device memory, virtual address may be translated using a translation lookaside buffer or page tables. For example, the virtual address can be translated using a translation lookaside buffer when accessing a cache like memory. In another example, the virtual address can be translated using a table walker of page tables, such as the tables of FIG. 6.

As illustrated at block 708, the memory controller determines with a function map table whether the virtual function requesting the memory access is associated with a device physical address translated from the function physical address. For example, when a virtual function is instantiated or in response to requests for additional storage, the memory controller can assign a device physical addresses to the virtual function and store a pairing of the identifier associated with the virtual function with the physical address. When a further memory access request is made, the memory controller can compare an identifier associated with the physical address in the function map table to the identifier of the virtual function making the memory access request and determine whether the virtual function has access to the physical address.

In some embodiments, the device can determine whether the device physical address is associated with the function physical address using the function map table. At block 710, the memory controller can determine with a function map table whether the device physical address is associated with the function physical address. For example, the function map table can include a field indicating which virtual function if any, owns the device physical page. In some embodiments, the device can determine whether the requested type of operation is permitted, as illustrated at block 712.

If it is determined that the virtual function has access to the device physical address, the device physical address is associated with a function physical address, and the operation type is allowed, the memory controller can complete the translation of the virtual address, as illustrated at block 718. At block 720, the memory access request can be performed and completed to provide the information to the virtual function. In some embodiments, the memory access request can be an information request from a virtual machine implemented on a processor in communication with the device. The decrypted information can be returned to the processor for access by the virtual machine. In some embodiments, the memory access request can include instructions for the virtual function to access and process the information. For example, a virtual function implemented on a graphics processing unit can access encrypted information and use the information to generate an image.

If the virtual function is not associated with the device physical address, the device physical address is not associated with the function physical address, or the operation type is not allowed, the translation of the virtual address is terminated at block 714 and the memory access request is denied at block 716.

In some embodiments, the apparatus and techniques described above are implemented in a system including one or more integrated circuit (IC) devices (also referred to as integrated circuit packages or microchips), such as the system described above with reference to FIGS. 1-6. Electronic design automation (EDA) and computer aided design (CAD) software tools may be used in the design and fabrication of these IC devices. These design tools typically are represented as one or more software programs. The one or more software programs include code executable by a computer system to manipulate the computer system to operate on code representative of circuitry of one or more IC devices so as to perform at least a portion of a process to design or adapt a manufacturing system to fabricate the circuitry. This code can include instructions, data, or a combination of instructions and data. The software instructions representing a design tool or fabrication tool typically are stored in a computer readable storage medium accessible to the computing system. Likewise, the code representative of one or more phases of the design or fabrication of an IC device may be stored in and accessed from the same computer readable storage medium or a different computer readable storage medium.

A computer readable storage medium may include any non-transitory storage medium, or combination of non-transitory storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

In some embodiments, certain aspects of the techniques described above may implemented by one or more processors of a processing system executing software. The software includes one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A method for managing access to device resources, the method comprising:
providing a device memory access request from a virtual function to a device memory controller to access a device memory, the virtual function associated with a virtual function identifier;
determining an encryption key associated with the virtual function using the virtual function identifier; and
decrypting with an encryption module an information stored at the device memory using the encryption key.

2. The method of claim 1, further comprising providing the decrypted information in a processor memory access request from the device to a virtual machine implemented on a processor in communication with the device.

3. The method of claim 1, processing the information in response to instructions from a virtual machine implemented on a processor in communication with the device.

4. The method of claim 1, wherein determining the encryption key includes determining the encryption key from a key table using the virtual function identifier.

5. The method of claim 1, further comprising:
providing from the virtual function a write request to the device memory controller, the write request including the information; and
encrypting the information of the write request based on the encryption key.

6. The method of claim 1, wherein the device memory access request has an associated physical address to be accessed, the method further comprising determining whether the device memory at the physical address is encrypted based on an indicator associated with the physical address in a translation table.

7. The method of claim 1, wherein the device memory access request has an associated device physical address, the method further comprising determining using a function map table whether the device memory at the device physical address is accessible to the virtual function based on the virtual function identifier.

8. The method of claim 1, further comprising determining using a function map table whether the device memory at a device physical address corresponds to a function physical address used in page table translation.

9. The method of claim 1, further comprising assigning the encryption key to the virtual function using a security module.

10. A method for managing access to a device memory of a device, the method comprising:
receiving at a device memory controller a device memory access request from a virtual function implemented on a computational resource of the device, the device memory access request including a virtual address;
translating using the memory controller the virtual address to a physical address of the device memory with a translation table;
determining whether virtual function has access to device memory at the physical address using a function map table; and
completing the device memory access request at the physical address when the virtual function has access to the device memory at the physical address.

11. The method of claim 10, further comprising providing information stored on the device memory at the physical address in a processor memory access request from the device to a virtual machine implemented on a processor in communication with the device.

12. The method of claim 10, wherein the function map table includes an entry pairing an identifier of the virtual function with the physical address.

13. The method of claim 10, further comprising determining whether information stored at the physical address of the device memory is encrypted using the translation table.

14. The method of claim 13, further comprising determining an encryption key based on an identifier associated with the virtual function and decrypting the information using the encryption key.

15. A system comprising:
a processor including a plurality of processor cores, a memory controller, and an input-output memory management unit, the plurality of processor cores to implement a plurality of virtual machines; and
a device in communication with the input-output memory management unit, the device including a bus controller, a device memory controller, an encryption module, a device memory, and a computational resource, the device to implement a plurality of virtual functions;
wherein the device is to:
provide a device memory access request from a virtual function of the plurality of virtual functions to the device memory controller to access the device memory, the virtual function associated with a virtual function identifier;
determine an encryption key associated with the virtual function using the virtual function identifier;
decrypt with the encryption module an information stored at the device memory using the encryption key; and
provide the decrypted information in a processor memory access request from the device to a virtual machine implemented on the processor.

16. The system of claim 15, wherein to determine the encryption key includes to determine the encryption key from a key table stored in the device memory using the virtual function identifier.

17. The system of claim 15, wherein the device is to further:
provide from the virtual function a write request to the device memory controller, the write request including the information;
encrypt the information of the write request based on the encryption key; and
store the encrypted information on the device memory.

18. The system of claim 15, wherein the device memory access request has an associated physical address to be accessed, wherein the device is to further determine whether the device memory at the physical address is encrypted based on an indicator associated with the physical address in a translation table.

19. The system of claim 15, wherein the processor memory access request has an associated physical address, wherein the device is to further determine using a function mapping table whether the device memory at the physical address is accessible to the virtual function based on the virtual function identifier.

20. The system of claim 15, wherein the device is to further assign the encryption key to the virtual function using a security module.
